(19) United States
(12) Patent Application Publication
(10) Pub. No.: US 2004/0151814 A1
(43) Pub. Date: Aug. 5, 2004

(54) Apparatus for applying treatment fluid to foodstuffs and methods related thereto

(75) Inventors: Timothy G. Richardson, Ellisville, MO (US); Monika U. Kopfinger, Brentwood, MO (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Alcide Corporation, Redmond, WA

(21) Appl. No.: 10/356,678

(22) Filed: Jan. 31, 2003

(51) Int. Cl. A23L 1/00

(52) U.S. Cl. 426/523; 99/348

(57) ABSTRACT

Improved apparatus and methods for applying treatment fluids, such as disinfectants, fungicides, flavoring agents, and tenderizing agents, to foodstuffs to, for example, reduce populations of microorganisms or fungi present thereon, or alter the taste or texture thereof. In representative embodiments, the apparatus includes an elongated housing structure, a fluid delivery system, and a shaft having one or more protruding members, the latter being adapted to agitatively convey the foodstuffs from an inlet to an outlet of the housing, as the fluid delivery system delivers a treatment fluid to the foodstuffs. The elongated housing structure forms a plurality of drain-openings therethrough and comprises one or more rider bars. In related embodiments, the present invention is directed to methods for applying such treatment fluids to foodstuffs, where the methods use the disclosed apparatus; and to elongated housing structures such as those of the disclosed apparatus.

### BACKGROUND OF THE INVENTION

1. Field of the Invention

The present invention relates to the treatment of foodstuffs to improve the edibility, longevity, and/or appearance thereof, and, more particularly, to the application of treatment fluids to foodstuff surfaces to remove contamination of, impart a desired flavor or texture to, tenderize or otherwise preserve the foodstuffs.

2. Description of the Related Art

Treatment of fresh foodstuffs for the purpose of improving edibility, longevity, and/or appearance is primarily directed to the removal of surface contamination. Fresh foodstuffs, including meats (e.g., beef, pork, poultry, etc.), seafood (e.g., fish and shellfish), fruits, and vegetables, are susceptible to surface contamination by various microorganisms, some of which are pathogenic. Improper cooking, as well as the spread of microorganisms via physical transfer to hands, food handling surfaces, and other foods, can result in gastrointestinal disorders that, in some cases, lead to death. Also, fungi and bacteria can deleteriously affect the appearance, taste, and smell of a variety of foodstuffs.

It has been reported that a high percentage of meats and seafood have surface contamination. For example, organisms in intestinal tracts may contact meat surfaces immediately after slaughter and evisceration. Bacterial examples include Salmonella and Campylobacter species, Listeria monocytogenes, Eschherichia coli, and other coliforms. Once bacteria such as Salmonella contact tissue surfaces, they rapidly attach and are difficult to remove. In beef processing, for example, a particularly virulent strain of E. coli, designated O157:E7, reportedly contaminated hamburger meat sold by a fast-food chain and caused several deaths in the United States in 1993. Salmonella typhimurium and Campylobacter jejuni are two organisms of significant concern in the poultry industry. It has been estimated that 35%-45% of the poultry reaching consumers is contaminated with Salmonella species. Breeders, hatcheries, feed ingredient suppliers, farms, processors, and distributors have all been implicated as contributors to such contamination in chickens and turkeys (Villarreal, M. E. et al., J. of Food Protection 53:465-467 (1990)). Contamination of only a few birds can lead to broader range contamination of other birds and cross-contamination to carcasses. It is not uncommon for E. coli to also contaminate seafood. In a recent study, 3-8% of samples of fresh fish purchased at supermarkets were found to have unacceptable levels of E. coli.

Fruits and vegetables, especially organic produce, often have surface contamination from various organisms, some of which are pathogenic, and which include bacteria, fungi, and nematodes (i.e., roundworms and threadworms). Contamination may occur during the growing season. Fields may be contaminated from wild animal feces or fertilization with manure-related products. Organic produce farmers often use fertilizer made from animal waste, rather than synthetic fertilizers. Composting the manure to kill the dangerous bacteria found therein is not always effective. Conventional farmers may also use manure. In addition, E. coli and other microbial infections may be present in pond water used to irrigate fields. Contamination of produce by fungi and bacteria may also occur during harvesting and storage and may arise from repeated handling of the produce, from the containers used for harvesting and storage, from processing and packaging equipment, from storage warehouse surfaces, and from the water used in post-harvest treatment or to clean warehouses. Some bacteria present on fruit and vegetable surfaces, such as Erwinia spp. and Pseudomonas spp., cause rot. Other bacteria are pathogenic. For example, Yersinia enterocolitica causes diarrhea, and Listeria monocytogenes causes listeriosis, a sometimes-fatal encephalitic disease. Examples of fungi are Alternaria sp. (causes black rot), Sclerotinia sclerotiorum (causes white mould), Botrytis cineria (causes gray mold), Acremonium apii (causes brown stain), and Phoma sp. (causes gangrene).

The rate of bacterial and fungal proliferation and resulting damage and health risk can, to some extent, be diminished by refrigeration, but there is a limit to the degree of refrigeration that can be imposed on meat, poultry, seafood, fruit, and vegetable products. Also, while freezing may be effective, this is not an option where such products are to be sold as “fresh.” Furthermore, some bacteria such as psychrophiles can survive and even flourish at temperatures approaching the freezing point. It is thus advantageous to control, destroy, or deactivate microbial and fungal contaminants during processing to reduce the initial population of organisms and/or fungi on the surface of foodstuffs. This approach has been appreciated in the art, and, accordingly, a variety of disinfecting and fungicidal chemical treatments have been applied to the surfaces of foodstuffs. Examples of such treatments include: ozonated water, acidified sodium chlorite, aqueous chlorine, quaternary ammonium solutions, phenolic compounds, and formaldehyde solutions.

However, methods of applying such chemical treatments, found in the prior art, are either inefficient in terms of utilization of the chemicals so as to minimize waste, or are ineffective, or simply not feasible, in treating a multitude of small-sized foodstuffs, such as fruits, vegetables, and seafood, or foodstuff parts, such as cut-up meat and seafood parts. For example, foodstuffs or foodstuff parts, regardless of their size, can be thoroughly contacted and effectively treated for surface contamination by microorganisms or fungus by dipping or otherwise being immersed in a bath or tank containing the appropriate chemical solution. However, this method has a number of drawbacks. First, it is inherently wasteful. Organic debris, destined to be discarded, inevitably ends up in the bath and consumes active chemical components as the latter attack the surface contaminants on the debris. Second, the contents of such baths become contaminated and, at some point, need to be discarded, even though they still contain unconsumed active chemicals. Finally, replacing the contents of chemical baths can be labor intensive.

Methods for treating surface contamination of foodstuffs by spray application of disinfecting and fungicidal chemical solutions are also known and practiced in the art. For example, a basic approach is to convey whole or partial animal carcasses past a plurality of spray applicators (i.e., nozzles) dispensing disinfectant while otherwise keeping the carcasses substantially immobilized (i.e., suspended from hooks). The entire surface, including interior surfaces of opened body cavities, can be effectively treated, given a sufficient number of spray applicators properly positioned and delivering a sufficient quantity of solution by means of effective spray patterns (see, e.g., U.S. Pat. No. 4,849,237 to Hurst).

However, while this approach may be feasible and effective for applying disinfectant to the surfaces of whole or partial animal carcasses, it is not suitable for treating the surfaces of a multitude of small-sized foodstuffs or foodstuff parts. Examples of small-sized foodstuffs that may need to be treated include fruits, vegetables, and seafood. Examples of foodstuff parts that may need to be treated include cut-up meat and seafood parts.

In addition to treatment of foodstuffs with disinfectants, other treatment fluids may also be applied to impart various desirable qualities. For example, edibility, longevity and/or appearance may be improved by application of seasonings, marinades, tenderizers, texturizers and preservatives.

Accordingly, there remains a need in the art for improved apparatus and methods for the efficient and effective application of such treatment fluids to foodstuffs and foodstuff parts, where the apparatus and methods can be readily integrated with an overall foodstuff processing plant. The present invention fulfills these needs and provides further related advantages.

### BRIEF SUMMARY OF THE INVENTION

The present invention relates to apparatus for use in, and to methods for applying treatment fluids to the surface of whole foodstuffs, or parts thereof, for the purpose of improving their edibility, longevity, and/or appearance. For example, disinfecting or fungicidal fluids may be applied to foodstuff surfaces to diminish or eliminate populations of microorganisms or fungi found thereon, thereby improving the edibility, longevity, and appearance of the foodstuff. In a number of embodiments, the fluids are applied as a spray while the whole foodstuffs, or parts thereof, are conveyed from an inlet end to an outlet end of the apparatus. Foodstuffs thereby treated include meat parts (e.g., parts of beef, pork, lamb, poultry, etc.) as well as poultry, seafood, fruits, and vegetables, in whole form or in parts. Typically, for removal of contamination, meat and seafood are treated with disinfectants, while fruits and vegetables are more typically treated with disinfectants and/or fungicides.

In one embodiment, the present invention is directed to an apparatus that comprises an elongated housing structure; a shaft rotatably engaged therewith and having a plurality of paddles and/or a spiral blade attached thereto and protruding therefrom, being thereby adapted to, upon rotation, agitatively convey foodstuffs from an inlet to an outlet end of the housing structure; and a fluid delivery system adapted to deliver a treatment fluid to the foodstuffs as they are so conveyed, so as to apply the treatment fluid to the surfaces thereof.

The elongated housing structure of the apparatus extends from the inlet end to the outlet end along a longitudinal axis and comprises first and second side-walls and a curved bottom-wall. The side-walls and bottom-wall extend from the inlet end to the outlet end and, when combined, form a generally U-shaped or semi-circular cross-section when viewed along the longitudinal axis. The elongated housing structure further comprises inlet and outlet end-walls and also forms an access-opening at the top thereof that extends along substantially the entire length thereof.

The bottom-wall forms a plurality of drain-openings therethrough along a substantial portion of its length, the drain-openings being adapted to allow a quantity of the treatment fluid to flow by gravity therethrough from the inside of the housing structure to the outside thereof. Additionally, the inlet end-wall and/or the outlet end-wall forms at least one drain-opening therethrough. The at least one drain-opening is adjacent to the intersection of the respective end-wall and the bottom-wall, and is adapted to allow a quantity of the treatment fluid to flow by gravity therethrough from the inside of the housing structure to the outside thereof.

The housing structure of the apparatus further comprises at least one rider bar. The at least one rider bar is fixedly attached to the inside of the bottom-wall, extends longitudinally along substantially the entire length thereof, and protrudes substantially uniformly therefrom to such a height as to provide a gap between the rider bar and each of the plurality of paddles and/or flights of the spiral blade as the shaft rotates through an angle of at least 360 degrees.

In another embodiment, the present invention is directed to an elongated housing structure extending along a longitudinal axis from an inlet end to an outlet end thereof. The housing structure is adapted for use with a shaft that is rotatably engaged with the housing structure so as to rotate about the longitudinal axis. Further, the shaft has a plurality of paddles and/or a spiral blade attached thereto, the shaft being thereby adapted to agitatively convey foodstuffs from the inlet end to the outlet end. The housing structure is further adapted for use with a fluid delivery system adapted to deliver a treatment fluid to the foodstuffs as they are agitatively conveyed, as described above.

The elongated housing structure comprises first and second side-walls and a curved bottom-wall that extend from the inlet end to the outlet end and form, when combined, a generally U-shaped or semi-circular cross-section when viewed along its longitudinal axis. The elongated housing structure further comprises inlet and outlet end-walls; and forms an access-opening at the top thereof that extends along substantially its entire length.

Additionally, the bottom-wall forms a plurality of drain-openings therethrough along a substantial portion of its length and substantially directly below the shaft, when instatlled. The drain-openings are adapted to allow the treatment fluid to flow by gravity therethrough from the inside of the housing structure to the outside thereof.

In a related embodiment, the elongated housing structure further comprises a drain-opening formed in the inlet end-wall thereof. The drain-opening is located adjacent to the intersection of the inlet end-wall and the bottom-wall and allows excess treatment fluid to flow through the inlet end-wall, by gravity, from the inside of the housing structure to the outside thereof.

In a yet further embodiment, the elongated housing structure further comprises at least one rider bar. Each rider bar is fixedly attached to the inside of the bottom-wall, extends longitudinally along substantially the entire length thereof, and protrudes substantially uniformly therefrom to such a height as to provide a gap between the rider bar and each of the plurality of paddles and/or flights of the spiral blade as the shaft, when installed and operating, rotates through an angle of at least 360 degrees.

In yet another embodiment, a method is disclosed for applying a treatment fluid to surfaces of foodstuffs while limiting contact between the surfaces of the foodstuffs and the treatment fluid delivered thereto. The method comprises introducing foodstuffs into an inlet end of an elongated apparatus that comprises a fluid delivery system; and delivering, by means of the fluid delivery system, an effective amount of a treatment fluid into the apparatus so as to effect contact between the treatment fluid and substantially all of the surfaces of the foodstuffs as the latter are agitatively conveyed from the inlet end to an outlet end of the apparatus.

Delivery of the effective amount of the treatment fluid is accomplished by providing a sufficient flow rate thereof from the fluid delivery system into the apparatus and providing a sufficiently long time of travel of the foodstuffs from the inlet end to the outlet end of the apparatus. Contact between the foodstuff surfaces and the treatment fluid delivered thereto is limited by allowing a quantity of the delivered treatment fluid to flow by gravity from the inside to the outside of the elongated apparatus through at least one of a plurality of drain-openings formed therein.

These and other aspects of this invention will be evident upon reference to the following detailed description of the invention and accompanying drawings.

### BRIEF DESCRIPTION OF THE SEVERAL VIEWS OF THE DRAWING(S)

FIG. 1 illustrates a perspective view of a treatment fluid application apparatus for foodstuffs, in accordance with an embodiment of the present invention, having a rotatable shaft/paddle assembly.

FIG. 2 illustrates a side view of the treatment fluid application apparatus of FIG. 1.

FIG. 3 illustrates a perspective view of the treatment fluid application apparatus of FIG. 1.

FIG. 4 illustrates a top view of a treatment fluid application apparatus for foodstuffs, in accordance with another embodiment of the present invention.

FIG. 5 illustrates a perspective view of a rotatable shaft/spiral blade assembly for use in a treatment fluid application apparatus, in accordance with yet another embodiment of the present invention.

FIG. 6 illustrates a perspective view of a rotatable shaft/spiral blade/paddle assembly for use in a treatment fluid application apparatus, in accordance with a further embodiment of the present invention.

FIG. 7 illustrates a top view of an improved embodiment of the elongated housing structure of the treatment fluid application apparatus of FIG. 1.

FIG. 8 illustrates an inlet end view of the elongated housing structure of FIG. 7.

FIG. 9 illustrates an embodiment of a means for collecting, for recycle or disposal, a quantity of delivered treatment fluid.

### DETAILED DESCRIPTION OF THE INVENTION

As noted above, the present invention is generally directed to methods and apparatus for applying treatment fluids to the surface of foodstuffs, in whole form or in parts thereof, for the purpose of improving their edibility, longevity, and/or appearance. As used herein, “treatment fluid” refers to, as some examples, a disinfectant, fungicide, flavoring agent (i.e., fluid comprising seasoning or spice), marinade, texturizer, tenderizer, or preservative, or mixtures thereof, where the treatment fluid may be in the form of a liquid or fluidizable solids. “Fluidizable solids” refers to a collection of solid particles that can be placed into a fluid-like motion and transported accordingly.

“Disinfectant” means an agent adapted to kill or otherwise deactivate microbes such as viruses, bacteria, as well as nematodes and other parasitic organisms. “Fungicide” means an agent adapted to kill or otherwise deactivate fungi and moulds. Examples of disinfectants and fungicides are: acidified sodium chlorite solutions, aqueous chlorine dioxide solutions, quaternary ammonia compounds, per-acid solutions, hydrogen peroxide, organic acids, chlorine and chlorine compounds, metal hypohalites, electrolyzed water, ozone solutions, phenol and cresol compounds, iodine and iodine compounds, natural floral or faunal extracts, enzymatic products, surface-active agents, parabens, alcohols, solutions of heavy metals, chlorhexidine, peroxygen compounds, triazines, and aldehydes, among others.

Embodiments of the present invention may allow an effective quantity of a treatment fluid to be applied to substantially the entire surface of foodstuffs as the latter are conveyed from the inlet end to the outlet end of the inventive apparatus. As used herein, the phrase “an effective quantity of treatment fluid” refers to that quantity of treatment fluid, delivered or applied to surfaces of foodstuffs, that yields a desired result, for example, a desired reduction of the population of microorganisms and/or fungi thereon, or a desired flavor, texture, longevity, tenderness, and so forth.

Foodstuffs that may be so treated include: meat parts, seafood in whole form or in parts thereof, and fruits and vegetables in whole form or in parts thereof. As used herein, “meat” means fresh meat from animals of the red meat variety (e.g., beef, lamb, venison, etc.) or of the white meat variety (e.g., poultry, pork, etc.). Also, as used herein “seafood” means fish or shellfish. Typically, where treatment fluids are disinfectants, they are applied in spray form to the surfaces of meat, poultry, or seafood in an effective quantity, i.e., so as to substantially reduce or eliminate populations of bacteria found on the surfaces. Typically, disinfecting or fungicidal fluids are likewise applied to the surfaces of fruits and vegetables to substantially reduce or eliminate populations of bacteria or fungi found thereon.

One skilled in the art may readily appreciate that, while it may be generally beneficial to so apply such treatment fluids to such foodstuffs, a detrimental result may follow from application of an excessive amount of treatment fluid to the foodstuffs. Such excessive application may result in either, the foodstuffs being in contact with the treatment fluid for too long a period of time, or the foodstuffs, after treatment, being coated or impregnated with too much treatment fluid. Possible consequences include unfavorably impacted coloration, texture or taste.

Accordingly, as used herein, “excess delivered treatment fluid” refers to that amount of delivered treatment fluid that results in the above-described, unfavorable length of contact time, or amount of treatment fluid coating or impregnating the foodstuffs after treatment; or simply to that amount of treatment fluid, delivered to the foodstuffs, but not carried away with the foodstuffs following the treatment thereof.

A number of specific details of certain embodiments of the invention are set forth in the following description and figures to provide a thorough understanding of such embodiments. One skilled in the art, however, will understand that the present invention may be practiced by way of additional embodiments or in the absence of some of the limitations set forth in the embodiments described below.

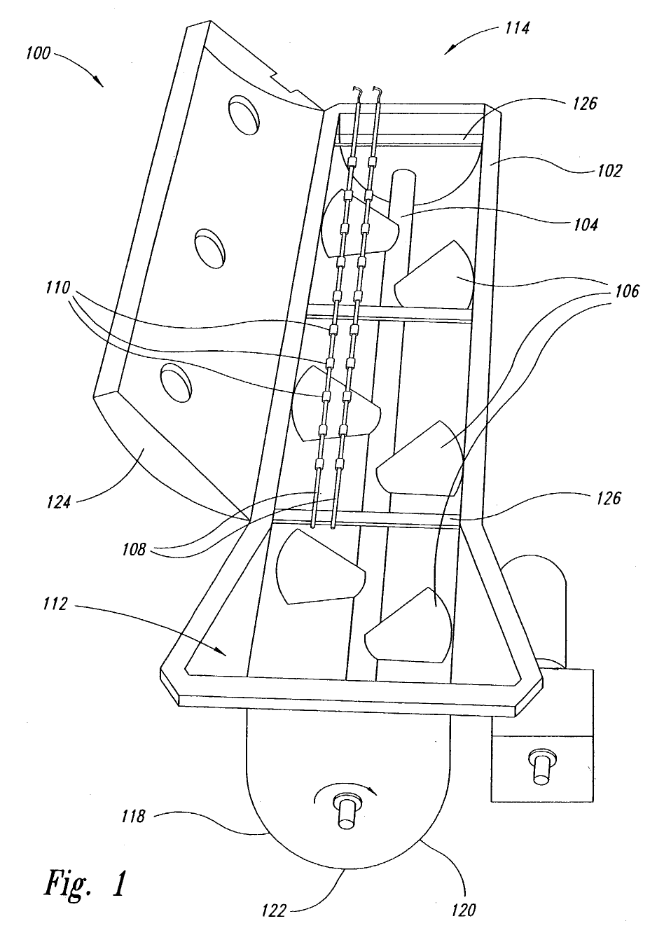

One embodiment is shown in FIGS. 1, 2, and 3, and described in detail below, as well as in U.S. Provisional Application No. 60/240,302 and U.S. Non-Provisional application Ser. No. 10/004,277, both of which are incorporated herein by reference in their entireties. In this embodiment, the present invention is directed to an apparatus 100 adapted to spray a treatment fluid in liquid form to foodstuffs as the latter are agitatively conveyed from an inlet end 112, toward an outlet end 114. As used herein, “agitatively conveyed” means conveyed while agitated and/or tumbled. The apparatus includes an elongated housing structure 102, a rotatable shaft 104 having a plurality of paddles 106 attached thereto along its length and protruding therefrom, and a fluid delivery system comprising two manifolds 108, each manifold being fitted with a plurality of spray nozzles 110.

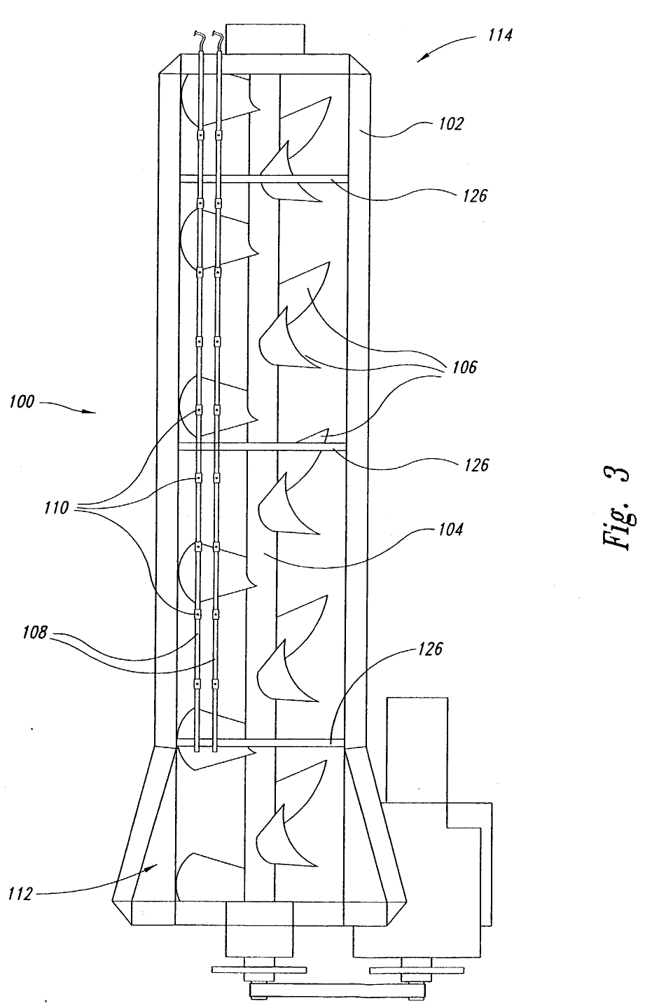

The elongated housing structure 102, as shown in FIG. 1, comprises a first side-wall 118, a second side-wall 120, an inlet end-wall 119, and an outlet end-wall 121, where the walls form an access-opening at the top of the elongated housing structure. The first side-wall 118 is to the left, and the second side-wall 120 is to the right, when the elongated housing structure 102 is viewed from the inlet end 112 toward the outlet end 114. As shown in FIGS. 1, 2, and 3, the plurality of spray nozzles 110 are spaced along the manifolds 108 so as to deliver the treatment fluid from a point near the inlet end 112 to a point near the outlet end 114 of the elongated housing structure 102. As shown in FIGS. 1 and 3, the two manifolds 108 are supported by three spreader bars 126 above the access-opening of the elongated housing structure 102. The two manifolds 108 are shown closer to the first side-wall 118 than to the second side-wall 120.

However, different embodiments are contemplated that may have only one manifold or more than two manifolds, fitted with a greater or lesser number of nozzles, and located above or below the opening to a housing structure. Also, the manifolds may be differently spaced, in the latitudinal direction, with respect to a housing structure.

As shown in FIG. 1, the latitudinal cross-section of the elongated housing structure is substantially U-shaped, the U-shape being formed from the substantially planar first side-wall 118, substantially planar second side-wall 120, and semi-circular bottom portion 122 of the elongated housing structure 102. The semi-circular bottom portion 122 has a diameter such that the gap between the distal ends of the plurality of paddles 106 and the semi-circular bottom portion 122 is substantially less than the smallest dimension of a treated foodstuff part. A gap distance of about 3/16″ is one example. Also shown is a lid 124, hingedly connected to the housing structure 102. The lid 124 is adapted to be closed to substantially cover the access-opening and, thereby, encase the shaft 104, plurality of paddles 106, and manifolds 108 in a covered enlongated housing structure. In other embodiments, the lid need not be hingedly or otherwise connected to the elongated housing structure when not substantially covering the access-opening thereof.

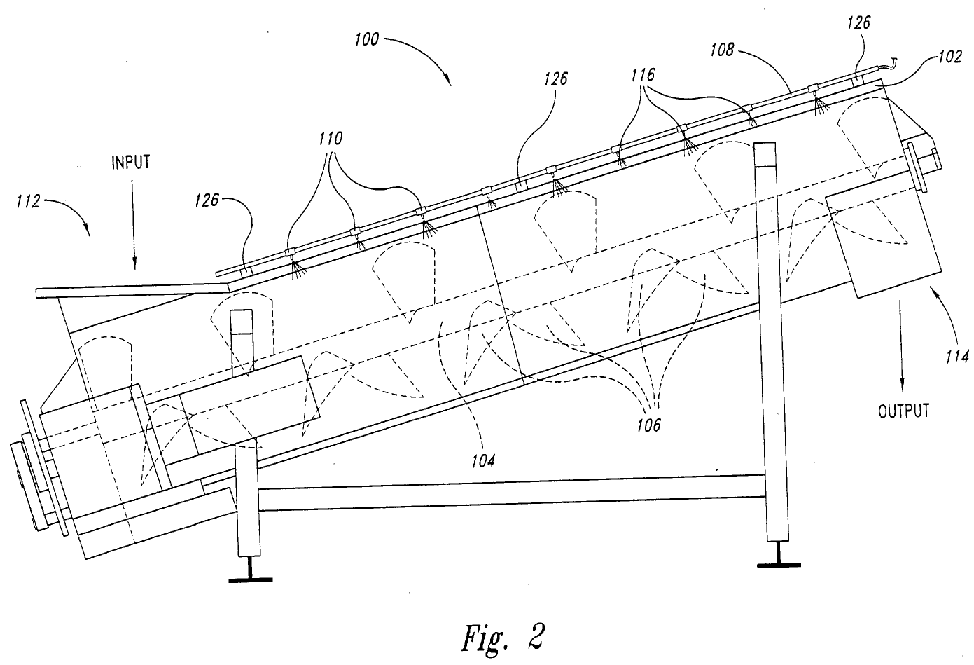

As shown most clearly in FIG. 2, the rotatable shaft 104 having the plurality of paddles 106 attached thereto and protruding therefrom resides within the elongated housing structure and is adapted to move foodstuffs (not shown) from the inlet end 112 to the outlet end 114 during processing. The rotatable shaft 104 has a round latitudinal cross-section and is, therefore, cylindrical. However, other latitudinal cross-sections are contemplated for the rotatable shafts comprised in embodiments of this invention. In all cases, the length of the shaft is much greater than its diameter. The rotational motion of the shaft is typically imparted to it by an electric motor coupled to the shaft by a transmission means. The plurality of paddles 106 are shown to be generally fan blade-shaped. However, other embodiments are contemplated where the paddles comprised therein are not fan blade-shaped.

The rotational motion of the shaft and paddles, combined with the geometry of the paddles, may impart both a translational and rotational motion to the foodstuffs, and, thus, may convey the latter along a generally spiral path from the inlet end 112 to the outlet end 114. The foodstuffs may depart from such a path to the extent that gravity causes them to tumble downward, and to the extent that both gravity and the close proximity of discrete foodstuff parts create agitation. Hence, the foodstuffs are described as being agitatively conveyed.

The fluid delivery system, as shown in FIGS. 1-3, is adapted to apply a liquid treatment fluid, as a spray 116 emitted from the plurality of spray nozzles 110, to the surface of the foodstuffs as the latter are agitatively conveyed from the inlet end 112 to the outlet end 114 of the elongated housing structure 102. The plurality of spray nozzles 110 may be configured to deliver a spray in the form of a fog or mist, or may be configured to deliver a full cone-shaped spray. A fan-shaped spray may also be delivered. Alternatively, some of the spray nozzles 110 may deliver a spray as a fog or mist, some may deliver a full cone-shaped spray, and some a fan-shaped spray.

Also, in one embodiment of the present invention, all of the plurality of spray nozzles 110 deliver about the same flow rate of treatment fluid, while in another embodiment, the spray nozzles located closer to the inlet end 112 deliver a higher flow rate of the treatment fluid than that delivered by the spray nozzles located closer to the outlet end 114. The latter embodiment may be used where it is desirable to reduce the amount of treatment fluid adhering to surfaces of foodstuffs after treatment.

In another embodiment, an apparatus comprises a fluid delivery system adapted to apply different types of treatment fluids to a particular foodstuff sample as the latter is conveyed from the inlet to the outlet of the apparatus. The different types of treatment fluids may be applied sequentially or simultaneously. As one example, for embodiments where the fluid delivery system has one or more manifolds, the fluid delivery system may apply one type of treatment fluid as the foodstuffs are initially conveyed away from the inlet. Then, by means of a switching valve or similar device, another type of treatment fluid may be delivered to the manifold(s) and applied to the foodstuffs as the latter are further conveyed toward the outlet.

As another example, for embodiments where the fluid delivery system has two manifolds, as foodstuffs are conveyed from the inlet to the outlet of the apparatus, one type of treatment fluid is delivered to one manifold and applied to the foodstuffs, and, at the same time, a different type of treatment fluid is delivered to the other manifold and applied to the foodstuffs.

Other embodiments are directed to apparatus with a fluid delivery system adapted to apply treatment fluids that are fluidizable solids, rather than liquids. Examples of such fluidizable solids are disinfectants, fungicides, seasonings, and preservatives in the form of a powder. One of ordinary skill in the art would appreciate that fluid delivery systems having manifolds and nozzles such as those shown in FIGS. 1-3, would not be effective for application of such fluidizable solids, and that the fluid delivery system would have to be modified, as needed, to use, for example, a sifter or other type of conveyance and delivery means suitable for fluidizable solids.

The above suggests additional embodiments directed to apparatus having fluid delivery systems comprising a combination of the above-described fluid delivery and application elements and, thereby, adapted to apply both liquid and fluidizable solid treatment fluids to a particular foodstuff sample, either sequentially or simultaneously.

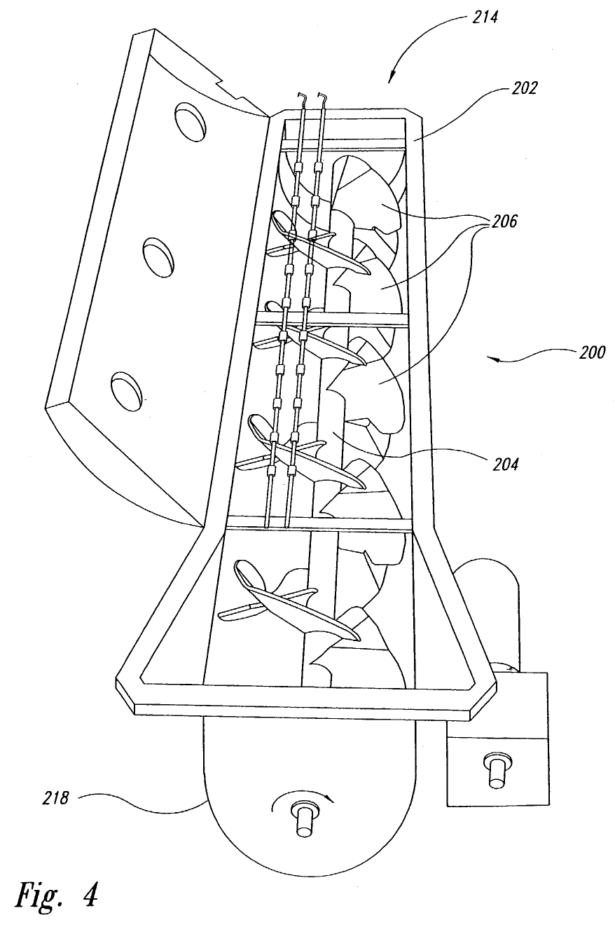

In another embodiment, the otherwise generally fan blade-shaped paddles each have a distal end bent toward the outlet end of a housing structure. FIG. 4 illustrates a more specific embodiment wherein an apparatus 200 comprises a rotatable shaft 204 having attached thereto and protruding therefrom a plurality of paddles 206, each having a bent distal end, the latter being bent toward an outlet end 214 of an elongated housing structure 202 and comprising a first bend and a second bend. It has been surprisingly discovered that these bends enhance the tendency of treated foodstuffs, at least where the foodstuffs are meat parts, to accumulate toward a first side-wall 218 when the rotatable shaft 204 and plurality of paddles 206 rotate in a clockwise fashion (the first side-wall 218 being to the left, and the rotation clockwise, when the elongated housing structure 202 is viewed from an inlet end 212 toward the outlet end 214 thereof).

The fluid delivery system may thus comprise first and second manifolds 208, the first manifold located generally above the rotatable shaft 204, and the second manifold located between the first manifold and the first side-wall 218. In other embodiments, the manifolds may both be located closer to one side-wall than to the other side-wall. However, in yet other embodiments, the manifolds may be positioned differently. For example, a first manifold may be positioned near a first side-wall, while a second manifold is positioned near a second side-wall.

In yet another embodiment, the apparatus of the present invention incorporates a conveyance assembly comprising a plurality of paddles that are attached to a rotatable shaft along a generally helical path, and that are aligned with a spiral plane projecting outwardly from the helical path. In one embodiment, the paddles are interconnected by a solid web that is also aligned with the spiral plane and attached to the shaft. Thus, there is formed a continuous, generally spiraling surface along an operable portion of the shaft, where there are essentially no gaps between the shaft and the interconnected paddles. In a more specific embodiment, a conveyance assembly includes a rotatable shaft and a plurality of paddles interconnected as described above by a solid web, wherein each of the plurality of paddles is a curved blade having a first portion in substantial alignment with the generally spiral surface, and a second distal portion forming angled distal surfaces angling away from the generally spiral surface and toward the outlet end of a housing structure. Such a conveyance assembly can be adapted for use in apparatus such as those shown in FIGS. 1-4 as an alternative to the shaft and paddle conveyance assemblies shown therein.

A further embodiment is directed to an apparatus such as that shown in FIGS. 1-3 or 4, but incorporating a conveyance assembly comprising a rotatable shaft having attached thereto and protruding therefrom, a spiral blade, rather than a plurality of paddles. The spiral blade continuously spirals around the rotatable shaft along an operable portion of its length, each 360° of traverse along the edge of the blade corresponding to one flight of the blade. In yet a further embodiment, each flight of the spiral blade comprises one or more protrusions attached thereto. Each protrusion continuously extends radially from the rotatable shaft, protrudes from the surface of the spiral blade toward an outlet end of a housing structure, and has a leading edge.

In specific embodiments, the number of protrusions comprised on each flight of the spiral blade is 1, 2, 3, 4, or more than 4, respectively. For some embodiments, where there is a plurality of protrusions comprised in a flight, the protrusions are spaced apart with substantially equal spacing. For other embodiments, where there is a plurality of protrusions comprised in a flight, the protrusions are spaced apart with substantially unequal spacing.

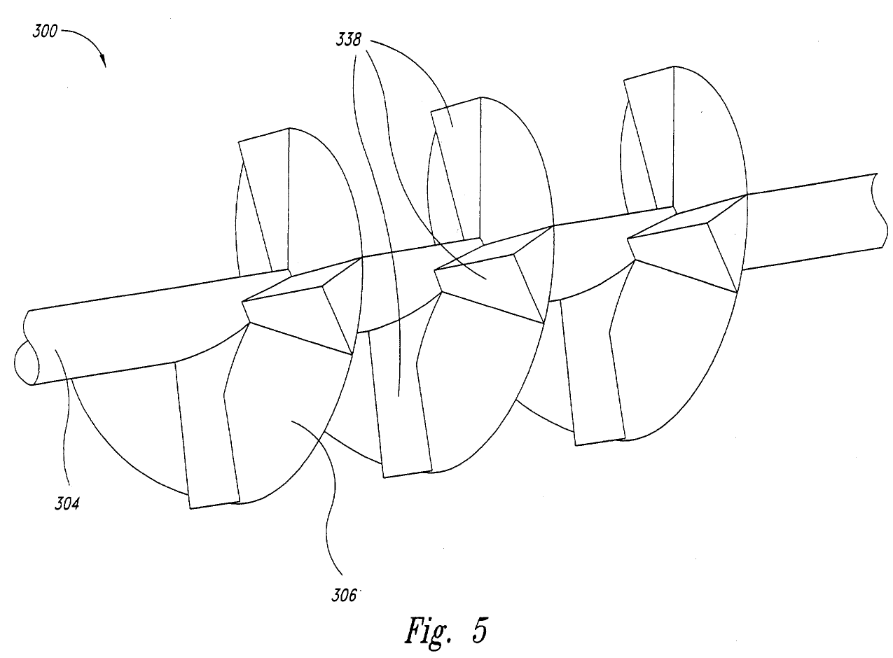

FIG. 5 illustrates a conveyance assembly 300 comprising a rotatable shaft 304 having attached thereto a spiral blade 306. As shown, each flight 336 of the spiral blade 306 has attached thereto four protrusions 338. The protrusions 338 are shown equally spaced apart (i.e., 90° from one protrusion to the next). Also as shown, each of the protrusions 338 is substantially V-shaped. As an example, the protrusions may be formed by welding 3″ angle-iron to the flights of the spiral blade. Or, the protrusions may be integrally formed with the blade. The conveyance assembly 300 shown in FIG. 5 can be adapted for use in apparatus such as those shown in FIGS. 1-4 as an alternative to the shaft and paddle assemblies shown therein.

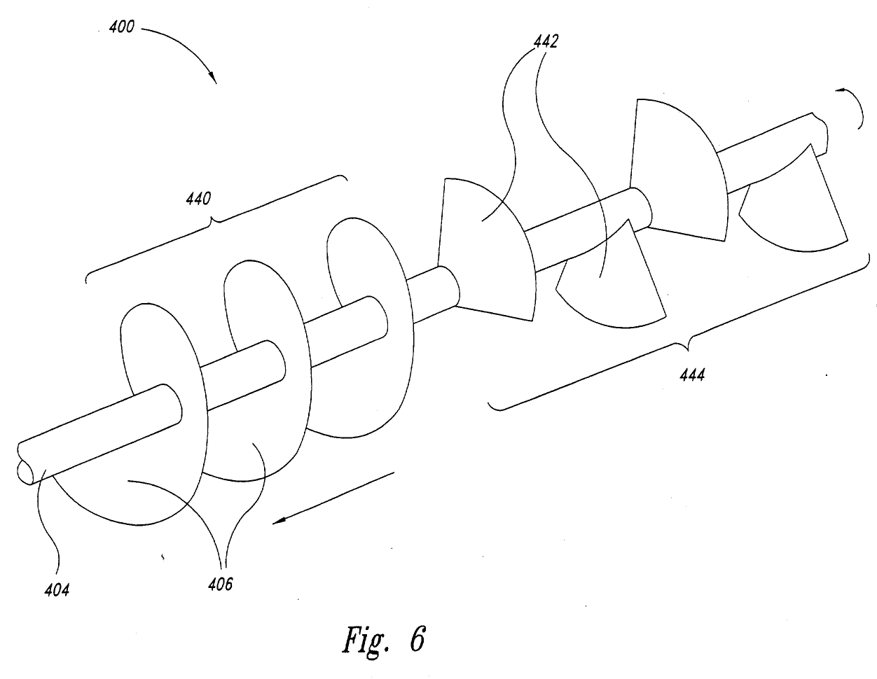

FIG. 6 illustrates an assembly 400, comprised in another embodiment of the present invention, wherein the assembly includes a rotatable shaft 404 having attached thereto a spiral blade 406 along a first longitudinal portion 440 of the shaft 404, and a plurality of generally fan blade-shaped paddles 442 attached thereto along a second longitudinal portion 444 of the shaft. In operation, as indicated in FIG. 6, the portion of the rotatable shaft 404 having the spiral blade 406 attached thereto is that portion closest to the inlet end 412 of the apparatus 400. In related embodiments, the spiral blade may have one or more protrusions attached thereto, as described above, and/or each of the plurality of paddles may have a bent distal end comprising one or more bends, as described above.

For the embodiments of the present invention that are directed to apparatus, the elongated housing structure, the rotatable shaft, the plurality of paddles, the spiral blade, the solid web interconnecting the plurality of paddles, and the protrusions comprised in the spiral blade, may be made of metal, and, more particularly, of stainless steel. Also, as shown for the illustrated embodiments directed to apparatus, the rotatable shaft with the plurality of paddles and/or spiral blade attached thereto, is adapted to agitatively convey foodstuffs from the inlet end to the outlet end of the apparatus when the shaft rotates in a clockwise fashion (as viewed from the inlet end toward the outlet end). One of ordinary skill in the art can readily appreciate, however, that other materials would be suitable, and that the apparatus could be configured to operate using a counter-clockwise rotation.

The inlet end of a disclosed apparatus may be level with respect to the outlet end, or the inlet end may be elevated in relation to the outlet end, or the outlet end may be elevated in relation to the inlet end. For example, FIG. 1 shows the outlet end 114 elevated in relation to the inlet end 112. In specific embodiments, the outlet end is elevated in relation to the inlet end to an extent such that the rotatable shaft is at an angle of about 10° to about 20° from the horizontal, or at an angle of about 15° from the horizontal, respectively. So that such angles of elevation may be readily realized, the housing structure can be mounted on adjustable legs.

There may be advantages to having the outlet end elevated in relation to the inlet end, or the inlet end elevated in relation to the outlet end, of the housing structure of the present invention. Such a configuration may expedite conveying foodstuffs from one piece of equipment to another in a processing plant. Also, as an example, it has been observed that, in some cases, foodstuffs are flipped more when conveyed from an inlet end to an outlet end elevated with respect thereto, as compared to being conveyed horizontally. The result may be better surface coverage by the treatment fluid delivered to the foodstuffs.

Also, when the outlet end is elevated in relation to the inlet end, a reservoir of delivered treatment fluid may or may not be maintained at the inlet end of the housing structure and used to initially immerse the foodstuffs entering the housing structure before they are then conveyed toward the outlet end while being sprayed with additional treatment fluid. Similarly, when the inlet end is elevated in relation to the outlet end, a reservoir of delivered treatment fluid may or may not be maintained at the outlet end of the housing sructure, and used to immerse the foodstuffs before exiting the apparatus. Accordingly, the housing structure of the embodiments of the present invention may comprise a drain near the inlet and/or outlet end thereof, wherein the drain is opened when no reservoir of treatment fluid is desired and closed when a reservoir is desired.

For some embodiments directed to apparatus having a conveyance assembly that comprises a generally spiral blade, it has been observed that, between flights of the blade, foodstuff pieces tend to cluster and, thereby retain treatment fluid (when in liquid form) as small pools, even when the outlet end of the housing structure is elevated in relation to the inlet end. The clustering results in an agitated motion of the foodstuff parts in the pool of treatment fluid, and apparently effective contact of all foodstuff surfaces with the treatment fluid. Inventors thereby appreciate that effective contact between foodstuff surfaces and treatment fluid may not, in some cases, require application of treatment fluid as an overhead spray. Instead, it may suffice to cause the treatment fluid to enter the elongated housing structure through its sidewalls as a spray or streams, or to enter the elongated housing structure by pooling up from its bottom portion.

In certain embodiments, it is desirable to limit the extent to which delivered treatment fluid pools, or otherwise collects, in the bottom of a disclosed apparatus. Accordingly, further embodiments, directed to an apparatus, are disclosed where the apparatus comprises: an elongated housing structure; a conveyance assembly rotatably engaged therewith and comprising a shaft having a plurality of paddles and/or a spiral blade attached thereto and protruding therefrom; and a fluid delivery system. The conveyance assembly and fluid delivery system are as described for the above-disclosed embodiments of disclosed apparatus.

The elongated housing structure of the apparatus extends from the inlet end to the outlet end along a longitudinal axis and comprises first and second side-walls and a curved bottom-wall. The side-walls and bottom-wall extend from the inlet end to the outlet end and, when combined, form a generally U-shaped or semi-circular cross-section when viewed along the longitudinal axis. The elongated housing structure further comprises inlet and outlet end-walls and also forms an access opening at the top thereof that extends along substantially the entire length thereof.

The bottom-wall forms a plurality of drain-openings therethrough along a substantial portion of its length, the drain-openings being adapted to allow a quantity of the treatment fluid to flow by gravity therethrough from the inside of the elongated housing structure to the outside thereof. Additionally, the inlet and/or outlet end-wall forms at least one drain-opening therethrough adjacent to the intersection of the inlet end-wall and the bottom-wall and adapted to allow a quantity of the treatment fluid to flow by gravity therethrough from the inside of the housing structure to the outside thereof.

The elongated housing structure of the apparatus further comprises at least one rider bar. Each rider bar is fixedly attached to the inside of the bottom-wall, extends longitudinally along substantially the entire length thereof, and protrudes substantially uniformly therefrom to such a height as to provide a gap between the rider bar and each of the plurality of paddles and/or spiral blade as the shaft rotates through an angle of at least 360 degrees.

As used herein, “rider bar” refers to any elongated protruding member, situated in the elongated housing structure as described above, and having a leading surface, namely, a surface comprising a leading edge and generally facing the direction of the lateral component of the motion of a foodstuff, being conveyed along the bottom-wall, so as to impede the lateral component of the motion. Also, the phrase “fixedly attached,” as used herein in connection with the rider bars, includes a fixed attachment that may be a permanent attachment or a removable attachment. An example of a permanent attachment is a rider bar that is welded to the bottom-wall. An example of a removable attachment is a rider bar that is attached to the bottom-wall by removable fasteners such as bolts and screws.

It has been found that rider bars, incorporated into the elongated housing structure as described above, can facilitate the conveyance of foodstuffs, having treatment fluid applied thereto, from the inlet to the outlet of the apparatus. As an example, a foodstuff piece can be partially sliced by the edge of a paddle or spiral blade of a conveyance assembly when caught between the edge and a side-wall or the bottom-wall. The foodstuff piece can then become wrapped over the edge and become difficult to longitudinally convey in the absence of a rider bar. When a rider bar is present, the leading surface thereof can dislodge such an otherwise trapped foodstuff piece and allow it to be conveyed toward the outlet end, often along the leading edge. Thus, the conveyed foodstuff piece “rides” up the apparatus (from the inlet to the outlet of the elongated housing structure) against the leading surface of the rider bar.

The drain-openings, formed in the bottom-wall, and in the inlet and/or outlet end-wall, as described above, serve to allow excess delivered treatment fluid to flow therethrough from the inside to the outside of the elongated housing structure, rather than pooling to an undesirable extent therewithin. Such pooling can, in some instances, result in excessive treatment of the foodstuffs with the treatment fluid. The consequences of such excessive treatment have been discussed previously.

In a more specific embodiment, at least one of the plurality of drain-openings formed in the bottom-wall is adjacent to the inlet and/or outlet end-wall. As noted, disclosed apparatus of the present invention may advantageously be operated with the outlet end thereof being elevated in relation to the inlet end thereof, or the inlet end being elevated in relation to the outlet end thereof. For example, when the outlet end is elevated in relation to the inlet end, delivered treatment fluid may pool to a greater extent at the inlet end and drainage thereof may be particularly desirable. Such drainage is expedited in the latter embodiment which has at least two drain-openings at the inlet end—at least one formed in the inlet end-wall and at least one formed in the bottom-wall, where the at least two drain-openings are adjacent to the intersection of the two walls. Having the at least two drain-openings at the inlet end is advantageous in that, if one drain-opening becomes obstructed, excess delivered treatment fluid may still flow through the other drain-opening.

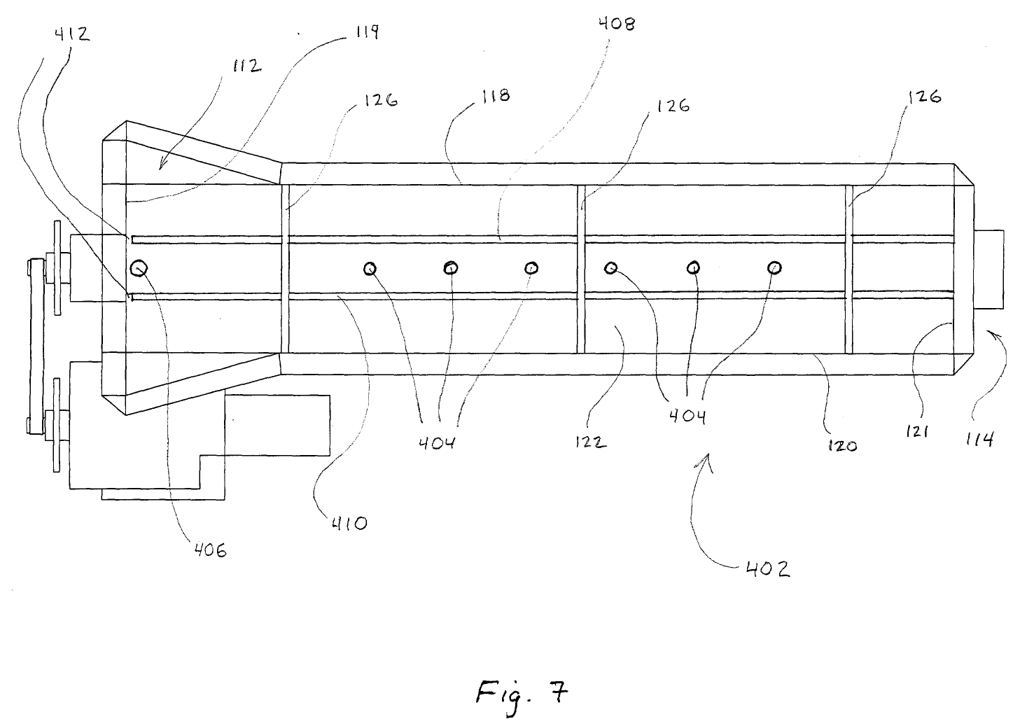

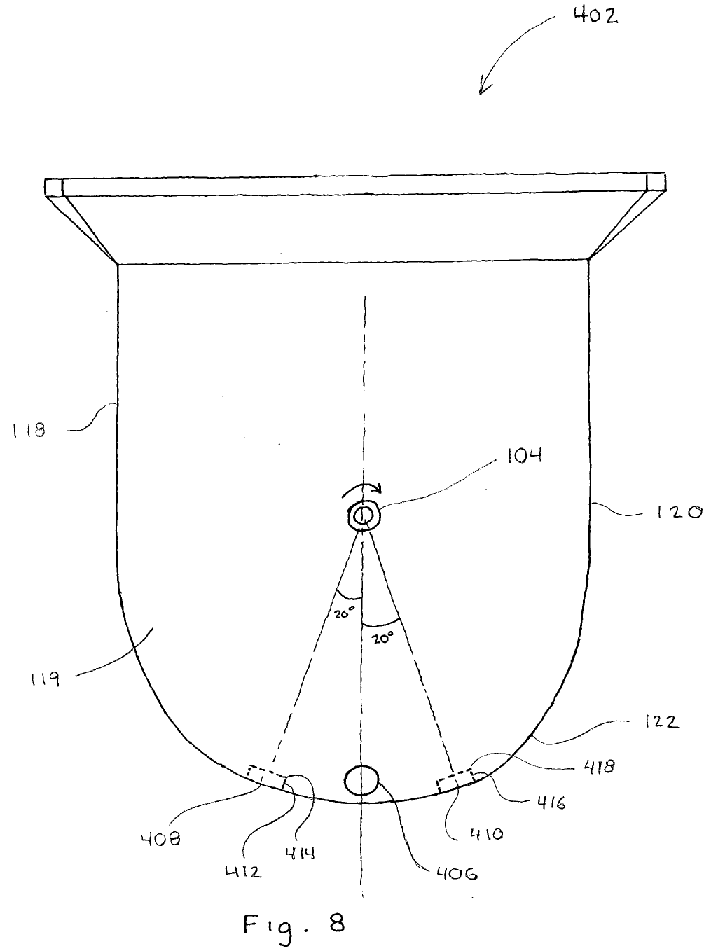

One specific embodiment of the elongated housing structure of a disclosed apparatus comprising drain-openings and at least one rider bar is shown in FIGS. 7 and 8, FIG. 7 being a top view thereof, and FIG. 8 being an end view thereof, with the inlet end shown. The elongated housing structure shown in FIGS. 7 and 8 is basically the same as that shown in FIGS. 1-4, except for the addition of the drain-openings and rider bars, and like parts are indicated by using the same part numbers therefor.

As shown in FIG. 7, the elongated housing structure 402 comprises six drain-openings 404 formed in the bottom-wall 122 thereof that are situated toward the longitudinal center of the bottom-wall 122 and generally away from the inlet end 112 and the outlet end 114 thereof. As shown, the drain-openings 404 are situated substantially directly below the shaft (not shown). Also, as shown in FIG. 7, the elongated housing structure 402 further comprises a drain-opening 406, formed in the bottom-wall 122 and located adjacent to the inlet end-wall 119. The illustrated drain-openings 404 and 406 are circular, with the diameter of the drain-opening 406 being greater than that of the drain-openings 404.

Also, as shown in FIG. 7, the elongated housing structure 402 further comprises a first rider bar 408, located between the drain-openings 404 and 406 and the first side-wall 118; and a second rider bar 410, located between the drain-openings 404 and 406 and the second side-wall 120. The rider bars 408 and 410 are shown extending along substantially the entire length of the elongated housing structure 402 from its inlet end-wall 119 to its outlet end-wall 121. A gap is shown between the inlet end-wall 119 and the rider bars 408 and 410.

FIG. 8 shows the inlet end view of the elongated housing structure 402, with the outside of the inlet end-wall 119 shown. Also shown are the inlet end of the shaft 104, the drain-opening 406 formed in the inlet end-wall, adjacent to the bottom-wall 122, and latitudinal cross-sections (shown in hidden lines) of the first rider bar 408 and the second rider bar 410. As shown, the first rider bar 408 has a rectangular latitudinal cross-section with a leading surface 412 and associated leading edge 414, and the second rider bar 410 also has a rectangular latitudinal cross-section with a leading surface 416 and associated leading edge 418.

Further, as illustrated, the rider bars 408 and 410 are attached to the inside surface of the bottom-wall 122, with the first rider bar 408 being offset by 20 degrees of rotation from that portion of the bottom-wall 122 directly below the shaft 104, toward the first side-wall 118, and the second rider bar 410 being offset by 20 degrees of rotation from that portion of the bottom-wall 122 directly below the shaft 104, toward the second side-wall 120.

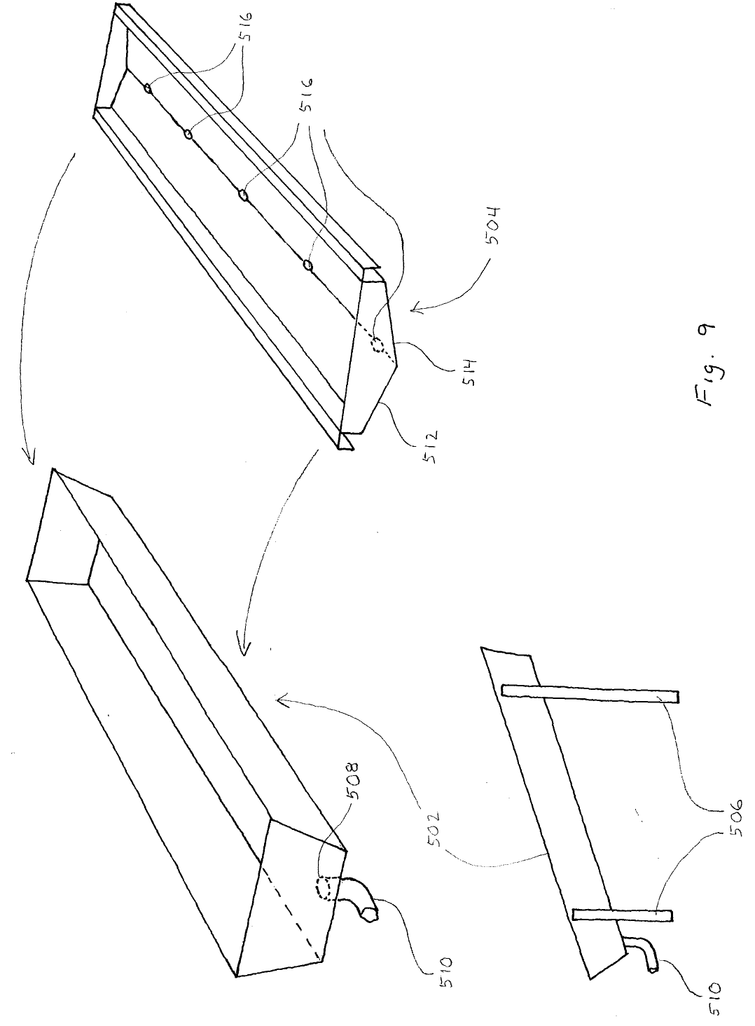

In a related embodiment, the disclosed apparatus further comprises a means for collecting the quantity of the delivered treatment fluid flowing through the plurality of drain-openings from the inside to the outside of the elongated housing structure. The collecting means is capable of collecting the quantity of the delivered treatment fluid in such a manner as to allow for its being recycled to the fluid delivery system or disposed of. A specific example of such a collecting means is shown in FIG. 9. In particular, illustrated is a drain trough 502 and a drip pan 504. Shown are a side view and perspective view of the drain trough 502. The side view shows the drain trough 502 supported and inclined from horizontal via adjustable vertical supports 506.

Typically, the drain trough 502 would be located directly below a disclosed treatment fluid application apparatus comprising drain-openings and would be inclined from horizontal to about the same degree as the apparatus. A quantity of delivered treatment fluid, flowing through the apparatus drain-openings can fall into the drain trough 502, then flow through the drain trough drain-opening 508, and then through the conduit 510 extending therefrom. The conduit 510 can direct the collected delivered treatment fluid to the fluid delivery system of a disclosed apparatus for recycle, or to a container or reservoir for disposal.

To minimize splash, the drip pan 504 may be installed on the top of the drain trough 502 and immediately below the apparatus. As shown, the drip pan 504 has angled bottom-walls 512 and 514 that slope downward toward the center thereof, and a plurality of drip pan drain-openings 516 through which captured applied treatment fluid can flow into the drain trough 502.

In related aspect, the present invention is directed to an elongated housing structure adapted for use with a shaft, where the shaft, when installed, is rotatably engaged with the housing structure so as to rotate about its longitudinal axis. The shaft typically has attached thereto one or more protruding members adapted to agitatively convey foodstuffs from an inlet end to an outlet end of the elongated housing structure. Examples of such a protruding member include, but are not limited to, a paddle and a spiral blade. The elongated housing structure is further adapted for use with a fluid delivery system, the latter adapted to deliver a treatment fluid to the foodstuffs, as they are agitatively conveyed from the inlet end to the outlet end, so as to expedite application of the treatment fluid to the surfaces thereof.

The elongated housing structure comprises first and second side-walls and a curved bottom-wall, the side-walls and bottom-wall extending from the inlet end to the outlet end and forming a generally U-shaped or semi-circular cross-section when viewed along the longitudinal axis; and wherein the elongated housing structure further comprises inlet and outlet end-walls; and wherein the elongated housing structure forms an access-opening at the top, the access-opening extending along substantially the entire length of the housing structure; and wherein the bottom-wall forms a plurality of drain-openings therethrough along a substantial portion of its length and substantially directly below the shaft, when installed, the drain-openings being adapted to allow a quantity of the treatment fluid to flow, by gravity, therethrough from the inside of the housing structure to the outside thereof.

In one related embodiment, at least one of the plurality of drain-openings formed in the bottom-wall is adjacent to the inlet and/or outlet end-wall. In a more specific related embodiment, each of the plurality of drain-openings formed in the bottom-wall is circular and the at least one of the plurality of drain-openings adjacent to the inlet and/or outlet end-wall has a diameter greater than that of the other of the plurality of drain-openings. This reflects the fact that excess delivered treatment fluid will tend to accumulate faster at the inlet end when the outlet end is elevated with respect to the inlet end, or faster at the outlet end when the inlet end is elevated in relation to the outlet end, during operation.

In a yet more specific embodiment, the diameter of the at least one drain-opening adjacent to the inlet and/or outlet end-wall is about 1 inch, and the diameter of the other of the plurality of drain-openings is about 0.75 inch. One skilled in the art can readily appreciate that drain-openings of other sizes and having other shapes can be used for the present invention.

A collar or flange may be welded to the bottom-wall below, and so as to circumscribe, at least one of the plurality of drain-openings and protrude downward from the outside surface of the bottom-wall. The collar serves to strengthen the bottom-wall at the location of a drain-opening, and to prevent the quantity of delivered treatment fluid, flowing therethrough, from running along the outside surface of the bottom-wall. Rather, the treatment fluid will tend to run down the inner surface of the collar and drip therefrom.

In another embodiment of the disclosed elongated housing structure, the latter further comprises at least one drain-opening formed in the inlet and/or outlet end-wall adjacent to the intersection thereof with the bottom-wall. The at least one inlet and/or outlet end-wall drain-opening is adapted to allow a quantity of delivered treatment fluid to flow therethrough, by gravity, from the inside to the outside of the disclosed elongated housing structure. In a more specific embodiment, the at least one inlet and/or outlet end-wall drain-opening is circular and has a diameter greater than that of the bottom-wall drain-openings of the disclosed embodiment wherein the bottom-wall drain-openings are also circular. In a yet more specific embodiment, the diameter of the at least one circular, inlet and/or outlet end-wall drain-opening is about 1.5 inches.

In a related embodiment, a length of conduit may be attached to the inlet and/or outlet end-wall so as to direct, away therefrom, treatment fluid flowing through the at least one drain-opening formed therethrough to the outside of the elongated housing structure. In this way, the treatment fluid may be prevented from running down the outside surface of the respective end-wall. As an example, the at least one drain-opening may be threaded, and a threaded 45° elbow screwed thereinto. Specific, non-limiting examples of drain-openings formed in the bottom-wall and inlet end-wall are shown in FIGS. 7 and 8. The advantage of having at least one drain-opening formed in the inlet and/or outlet end-wall, as well as in the bottom-wall, adjacent to the intersection thereof, has been discussed previously.

The present invention, in yet another related embodiment, is directed to a disclosed elongated housing structure that comprises a plurality of drain-openings formed in the bottom-wall and at least one drain-opening formed in the inlet and/or outlet end-wall, and further comprises means for regulating the flow of a quantity of the delivered treatment fluid through at least one of the drain-openings. Such means, as would be readily appreciated by one skilled in the art, may be an adjustable valve. It may be advantageous to adjust the flow of the quantity of the delivered treatment fluid through the at least one drain-opening to, thereby, provide for a desired degree of pooling of the excess delivered treatment fluid to, in turn, yield a desired extent of contact between the treatment fluid and foodstuffs treated therewith.

A disclosed elongated housing structure, in another embodiment, in addition to comprising a plurality of drain-openings formed in the bottom-wall and at least one drain-opening formed in the inlet and/or outlet end-wall, further comprises at least one rider bar, fixedly attached to the inside of the bottom-wall and longitudinally extending substantially along the entire length of the elongated housing structure. Further, the at least one rider bar substantially uniformly protrudes from the inside surface of the bottom-wall to such a height as to provide a gap between the rider bar and each of the plurality of paddles and/or flights of the spiral blade as the shaft rotates through an angle of at least 360 degrees. As one example, the gap may be about 0.125 inch. Such rider bars have been discussed previously.

In a more specific embodiment, the at least one rider bar is a first and a second rider bar. The two rider bars are each offset away from that portion of the bottom-wall that is substantially directly below the shaft, the former being offset toward the first side-wall, and the latter toward the second side-wall. In other more specific embodiments, the offset for each of the two rider bars corresponds to a range of from about 20 to about 45 degrees of rotation, and to a about 20 degrees of rotation, respectively. A specific example of rider bars, where the offset corresponds to 20 degrees of rotation, is shown in FIGS. 7 and 8 and has been discussed previously.

At least one rider bar, in a yet further, more specific embodiment, has a latitudinal cross-section that defines a quadrilateral or triangle. In a yet more specific embodiment, the quadrilateral is a square, rectangle, trapezoid or parallelogram. As can be readily appreciated by one skilled in the art, the shape defined by the latitudinal cross-section is not critical, as long as the rider bar has a leading surface and associated leading edge effectively functioning as discussed previously. In a related embodiment, there is a gap between the inlet end-wall and the end, closest thereto, of at least one of the plurality of rider bars. An example of such a gap are the gaps 412 shown in FIG. 7. Having such a gap may be advantageous in allowing excess delivered treatment fluid to flow therethrough toward that portion of the bottom-wall having the plurality of drain-openings formed therein.

In another related embodiment, at least one rider bar comprises at least one channel formed therein, wherein the channel runs laterally through the rider bar, adjacent to the inside of the bottom-wall, so as to fluidly connect its leading surface and its surface opposite thereto, and wherein the channel is adapted to allow a quantity of delivered treatment fluid to flow therethrough toward that portion of the bottom-wall having the plurality of drain-openings formed therein.

In another embodiment, the disclosed elongated housing structure further comprises a hingedly connected or removable top adapted to substantially cover the access-opening when closed or installed, respectively.

The present invention, in another aspect, is further directed to a representative method for delivering a quantity of a treatment fluid so as to apply at least a portion thereof to surfaces of foodstuffs, while limiting, after delivery of the treatment fluid, contact between the same and the surfaces of the foodstuffs. The disclosed method comprises the steps of introducing foodstuffs into an inlet end of an elongated apparatus comprising a fluid delivery system; and delivering, by means of the fluid delivery system, an effective amount of the treatment fluid into the apparatus so as to effect contact between the treatment fluid and substantially all of the surfaces of the foodstuffs as the latter are agitatively conveyed from the inlet end to an outlet end of the apparatus.

Delivery of the effective amount of the treatment fluid is accomplished by providing a sufficient flow rate of the treatment fluid from the fluid delivery system into the apparatus, and a sufficiently long time of travel of the foodstuffs from the inlet end to the outlet end of the apparatus. The contact between the surfaces of the foodstuffs and the delivered treatment fluid is limited by means of allowing a quantity of the delivered treatment fluid to flow by gravity from the inside to the outside of the apparatus through at least one of a plurality of drain-openings formed in the apparatus.

In a related, more specific embodiment, the present invention is directed to the above-disclosed representative method wherein the elongated apparatus used therefor is an above-disclosed apparatus, i.e., the elongated housing structure thereof comprises a bottom-wall having a plurality of drain-openings formed therein; inlet and outlet end-walls having at least one drain-opening formed in one or both thereof; and at least one rider bar fixedly attached to the inside of the bottom wall.

The present invention, in another related embodiment, is directed to the above-disclosed representative method, further comprising collecting at least a portion of the quantity of delivered treatment fluid, flowing through the at least one of the plurality of drain-openings, in such a manner as to allow for disposal of the same, or recycling of the same to the fluid delivery system. In a related, more specific embodiment, the present invention is directed to the latter-disclosed method wherein the elongated apparatus used therefor is an above-disclosed apparatus that comprises the above-disclosed means for so collecting the at least a portion of the quantity of delievered treatment fluid.

For disclosed methods of the present invention, an effective amount of a treatment fluid may be delivered as a spray for application to the surfaces of the foodstuffs as the latter are agitatively conveyed from the inlet end to the outlet end of the apparatus. More specifically, foodstuffs, such as meat parts, or such as seafood, vegetables, or fruits, in whole form or in parts thereof, may be introduced into the inlet end of the enlongated housing structure of a disclosed apparatus of the present invention. After the foodstuffs are introduced into the inlet end, they are agitatively conveyed toward the outlet end by the rotatable shaft, having a plurality of paddles and/or a spiral blade attached thereto, as it rotates.

For some embodiments, while the foodstuffs are being conveyed, they are sprayed with a treatment fluid delivered from a plurality of overhead spray nozzles. Surface coverage by the treatment fluid may be achieved by direct contact between the foodstuff surfaces and delivered treatment fluid; by contact between the foodstuff surfaces and other foodstuff surfaces having delivered treatment fluid contained thereon; by contact between the foodstuff surfaces and pooled, delivered treatment fluid; or by contact between the foodstuff surfaces and various apparatus surfaces (e.g., housing structure, rotatable shaft, paddles and/or helically-shaped blades, etc.) having delivered treatment fluid present thereon.

As a specific example, the treatment fluid may be a disinfecting fluid that is an aqueous solution containing from about 0.001% to about 0.2% by weight of a metal (such as sodium or potassium) chlorite and an amount of an acid sufficient to adjust the pH of the solution to from about 2 to about 5, or from about 2.2 to about 4.5, to maintain the chlorite ion concentration in the form of chlorous acid to not more than about 35% by weight of the total amount of chlorite ion concentration in the solution, and to minimize chlorine dioxide generation. Such disinfectant solutions have been disclosed in U.S. Pat. No. 5,389,390, which is incorporated herein by reference in its entirety.

Delivery of a treatment fluid may be accomplished by a variety of techniques in other ways. Where the treatment fluid is a liquid, it may also be delivered through the sidewalls of the housing structure as either a spray or streams. Or, it may be delivered through the bottom-wall of the elongated housing structure so as to pool up from the bottom to some desired extent. Effective coverage of foodstuff surfaces is then achieved by the mechanisms for mass transfer described in the preceding paragraph. Where the treatment fluid is a fluidizable solid, it may be delivered as such under pressure or by using a fluid delivery system that incorporates a sifter or other such device.

From the foregoing, it will be appreciated that all of the specific embodiments and examples described above have been presented for purposes of illustration, and that various modifications may be made without deviating from the spirit and scope of the invention. Accordingly, the present invention is not limited except insofar as it is by the appended claims.

1. An apparatus comprising:
an elongated housing structure;
a shaft;
a plurality of paddles and/or a spiral blade attached to and protruding from the shaft; and
a fluid delivery system,
wherein the elongated housing structure comprises a first side-wall, a second side-wall, a curved bottom-wall, an inlet end, an outlet end, an inlet end-wall, an outlet end-wall, and at least one rider bar, and wherein: 1) the elongated housing structure extends along a longitudinal axis from the inlet end to the outlet end; 2) the elongated housing structure is adapted for use with the shaft, the shaft being rotatably engaged with the housing structure so as to rotate about the longitudinal axis and, together with the plurality of paddles and/or spiral blade, also being adapted to agitatively convey foodstuffs from the inlet end to the outlet end; 3) the elongated housing structure is further adapted for use with a fluid delivery system adapted to apply a treatment fluid to the foodstuffs as they are so conveyed; 4) the first and second side-walls and curved bottom-wall extend from the inlet end to the outlet end and form a generally U-shaped or semi-circular cross-section when viewed along the longitudinal axis; 5) the first and second side-walls, inlet end-wall and outlet end-wall form an access-opening at the top thereof, the access-opening extending along substantially the entire length of the elongated housing structure; 6) the bottom-wall forms a plurality of drain-openings therethrough along a substantial portion of the length thereof and substantially directly below the shaft, the drain-openings being adapted to allow a quantity of the delivered treatment fluid to flow, by gravity, therethrough from the inside of the housing structure to the outside thereof; 7) the at least one rider bar is fixedly attached to the inside of the bottom-wall, longitudinally extends substantially along the entire length thereof and substantially uniformly protrudes therefrom to such a height as to provide a gap between the rider bar and each of the plurality of paddles and/or flights of the spiral blade as the shaft rotates through an angle of at least 360 degrees; and 8) the fluid delivery system is adapted to deliver a treatment fluid to the foodstuffs as the same are agitatively conveyed from the inlet end to the outlet end.

2. The apparatus of claim 1 wherein at least one of the plurality of drain-openings formed in the bottom-wall is adjacent to the inlet and/or outlet end-wall.

3. The apparatus of claim 1 further comprising a means for collecting the quantity of the delivered treatment fluid flowing through the plurality of drain-openings from the inside to the outside of the elongated housing structure, the collecting being carried out in such a manner as to allow for recycling of at least a portion of the quantity of the delivered treatment fluid, so collected, to the fluid delivery system.

4. An elongated housing structure comprising a first side-wall, a second side-wall, a curved bottom-wall, an inlet end, an outlet end, an inlet end-wall and an outlet end-wall, wherein: 1) the elongated housing structure extends along a longitudinal axis from the inlet end to the outlet end; 2) the elongated housing structure is adapted for use with a shaft, the shaft being rotatably engaged with the housing structure so as to rotate about the longitudinal axis and, together with a plurality of paddles and/or a spiral blade attached thereto and protruding therefrom, also being adapted to agitatively convey foodstuffs from the inlet end to the outlet end; 3) the elongated housing structure is further adapted for use with a fluid delivery system adapted to apply a treatment fluid to the foodstuffs as they are so conveyed; 4) the first and second side-walls and curved bottom-wall extend from the inlet end to the outlet end and form a generally U-shaped or semi-circular cross-section when viewed along the longitudinal axis; 5) the first and second side-walls, inlet end-wall and outlet end-wall form an access-opening at the top thereof, the access-opening extending along substantially the entire length of the elongated housing structure; 6) the bottom-wall forms a plurality of drain-openings therethrough along a substantial portion of the length thereof and substantially directly below the shaft, when installed, the drain-openings being adapted to allow a quantity of the delivered treatment fluid to flow, by gravity, therethrough from the inside of the housing structure to the outside thereof.

5. The elongated housing structure of claim 4 wherein at least one of the plurality of drain-openings formed in the bottom-wall is adjacent to the inlet and/or outlet end-wall.

6. The elongated housing structure of claim 5 wherein each of the plurality of drain-openings is circular and wherein the at least one of the plurality of drain-openings that is adjacent to the inlet and/or outlet end-wall, has a diameter larger than the diameter of the other of the plurality of drain-openings.

7. The elongated housing structure of claim 6 wherein the diameter of the at least one of the plurality of drain-openings that is adjacent to the inlet and/or outlet end-wall, is about 1 inch, and the diameter of the other of the plurality of drain-openings is about 0.75 inch.

8. The elongated housing structure of claim 4 wherein a collar is welded to the bottom-wall below, and so as to circumscribe, at least one of the plurality of drain-openings, the collar protruding downward therefrom.

9. The elongated housing structure of claim 4 wherein the inlet and/or outlet end-wall forms at least one drain-opening therethrough, adjacent to the intersection of the inlet and/or outlet end-wall and the bottom-wall, and adapted to allow a quantity of the delivered treatment fluid to flow by gravity therethrough from the inside of the elongated housing structure to the outside thereof.

10. The elongated housing structure of claim 9 further comprising a conduit attached to the inlet and/or outlet end-wall so as to direct, away therefrom, the quantity of the delivered treatment fluid flowing through the drain opening formed therethrough from the inside to the outside of the housing structure.

11. The elongated housing structure of claim 10, further comprising means for regulating the flow of the quantity of delivered treatment fluid flowing through at least one of the drain-openings formed in the bottom-wall and inlet and/or outlet end-wall.

12. The elongated housing structure of claim 9 wherein the at least one drain-opening formed in the inlet and/or outlet end-wall is circular and has a diameter larger than that of the plurality of drain openings formed in the bottom-wall of the elongated housing structure of claim 6.

13. The elongated housing structure of claim 12 wherein the diameter of the at least one drain-opening formed in the inlet and/or outlet end-wall is about 1.5 inches.

14. The elongated housing structure of claim 4, further comprising at least one rider bar fixedly attached to the inside of the bottom-wall, longitudinally extending substantially along the entire length thereof, and substantially uniformly protruding therefrom to such a height as to provide a gap between the rider bar and each of the plurality of paddles and/or flights of the spiral blade as the shaft rotates through an angle of at least 360 degrees.

15. The elongated housing structure of claim 14 wherein the at least one rider bar is a first rider bar and a second rider bar, the first rider bar being offset toward the first side-wall and away from that portion of the bottom-wall that is substantially directly below the shaft, when installed, and the second rider bar being offset toward the second side-wall and away from that portion of the bottom-wall that is substantially directly below the shaft, when installed.

16. The elongated housing structure of claim 15 wherein the offset for each of the first and second rider bars is in the range of from about 20 to about 45 degrees of rotation from that portion of the bottom-wall that is substantially directly below the shaft, when installed, toward the first and second side-walls, respectively.

17. The elongated housing structure of claim 16 wherein the offset for each of the first and second rider bars is about 20 degrees of rotation from that portion of the bottom-wall that is substantially directly below the shaft, when installed, toward the first and second side-walls, respectively.

18. The elongated housing structure of claim 14 wherein the at least one rider bar has a latitudinal cross-section that defines a quadrilateral or a triangle.

19. The elongated housing structure of claim 18 wherein the quadrilateral is a square, rectangle, trapezoid or parallelogram.

20. The elongated housing structure of claim 14 wherein there is a gap between the inlet end-wall and the end, closest thereto, of the at least one rider bar.

21. The elongated housing structure of claim 14 wherein at least one rider bar comprises at least one channel formed therein, wherein the channel runs laterally through the rider bar, adjacent to the inside of the bottom-wall, so as to fluidly connect the leading surface of the rider bar and its surface opposite thereto, and wherein the channel is adapted to allow a quantity of delivered treatment fluid to flow therethrough toward the portion of the bottom-wall having the plurality of drain-openings formed therein.

22. The elongated housing structure of claim 14 further comprising a hingedly connected or removable top configured to cover the access-opening when closed or installed, respectively.

23. A method for delivering a quantity of treatment fluid so as to apply at least a portion thereof to surfaces of foodstuffs while limiting, after delivery of the treatment fluid, contact between the delivered treatment fluid and the surfaces of the foodstuffs, comprising:
introducing foodstuffs into an inlet end of an elongated apparatus that comprises a fluid delivery system; and
delivering, by means of the fluid delivery system, an effective amount of the treatment fluid into the apparatus so as to effect contact between the treatment fluid and substantially all of the surfaces of the foodstuffs as the latter are agitatively conveyed from the inlet end to an outlet end of the apparatus, delivery of the effective amount of the treatment fluid being accomplished by providing a sufficient flow rate of the treatment fluid from the fluid delivery system into the apparatus and providing a sufficiently long time of travel of the foodstuffs from the inlet end to the outlet end of the apparatus; and the contact between the surfaces of the foodstuffs and the delivered treatment fluid being limited by means of allowing a quantity of the delivered treatment fluid to flow by gravity from the inside to the outside of the apparatus through at least one of a plurality of drain-openings formed in the apparatus.

24. The method of claim 23 wherein the elongated apparatus is the apparatus of claim 1.

25. The method of claim 23, further comprising collecting the quantity of delivered treatment fluid in such a manner as to allow for recycling at least a portion of the same to the fluid delivery system.

26. The method of claim 25 wherein the elongated apparatus is the apparatus of claim 3.
